(19) United States
(12) Patent Application Publication
(10) Pub. No.: US 2003/0095854 A1
(43) Pub. Date: May 22, 2003

(54) Tug for aircraft

(76) Inventor: Rene Abela, New South Wales (AU)

Correspondence Address: Albin H Gess, Price and Gess, Suite 250, 2100 S E Main Street, Irvine, CA, 92617, US

(21) Appl. No.: 10/168,350

(22) PCT Filed: Dec. 13, 2000
(86) PCT No.: PCT/AU00/01540

(30) Foreign Application Priority Data
Dec. 14, 1999 (AU) PQ 4630

(51) Int. Cl. B60B 29/00

(52) U.S. Cl. 414/426; 180/904; 414/428

(57) ABSTRACT

An articulated tractor (10) for towing an aircraft comprising a front section (10A) including an engine means (18) and a rear section (10B) pivoted to the front section (10a), the rear section (10B) defining a nose wheel clamp means (34) for engaging and raising the nose wheel (36) of an aircraft. In another embodiment the clamping force applied to the nose wheel (36) by the nose wheel clamp means (34) is proportional to the mass of the nose wheel (32). Still in another embodiment the nose wheel clamp means (34) are provided with relief valve means to relieve if the raising force applied to the nose wheel (36) increases beyond a predetermined limit.

### FIELD OF THE INVENTION

This invention relates to a tug for towing an aircraft, such as are often referred to as an aircraft tractors.

### BACKGROUND OF THE INVENTION

Aircraft tugs or tractors are a common sight at commercial airports around the world. They are used to tow aircraft around the airport. Typically, aircraft tugs are used to tow aircraft front departure gates to the taxi way for take-off, to hangers, or anywhere that the aircraft either cannot travel to under its own power, or is not permitted to travel to under its own power by airport regulations or the like. Most commercial jet powered passenger and freight aircraft are sufficiently large to require towing.

Early aircraft tugs were large four wheel drive vehicles/tractors with a tow bar which attached to the nose wheel of the aircraft for towing the aircraft. From the 1950 and 1960 onwards, commercial aircraft became progressively heavier. Such relatively heavier aircraft necessitated an increase in the weight of the tractors to ensure that sufficient ground friction existed for the tractor to be able to tow the relatively heavier aircraft. This type of tractor still operates in many airports around the world today.

However, around 20 years ago, an improved aircraft tug was invented which relied on the use of a relatively light tug vehicle but which was designed to let the nose wheel/gear of the aircraft ride an the tug, thus using the nose weight of the aircraft as ballast and increasing the effective weight of the tug. This type of (“towbarless” or “light”) tug has gained widespread acceptance. They operate in the following manner. The tug is moved so that the nose wheel is located in a bay in the tug, the nose wheel is grasped by a mechanism on the tug and lifted up a small distance front the ground usually around 200 mm. The tug can then be driven to pull the aircraft . Light tugs have four wheel drive. The bay for the nose wheel of the aircraft is located in the middle of the tug so that the nose weight is equally distributed to all four driving wheels. This also ensures that the load on the tug is evenly balanced and stable. “Light” tugs come in varying sizes to accommodate different sizes of aircraft with the relatively larger “light” tugs being used for larger planes.

However, there are a number of problems with existing aircraft tugs of the above type and in particular in the manner in which the tugs interact with the nose gear of the aircraft. When an aircraft lands, it lands on its landing gear which are the main wheels which are located to the rear of the middle of the plane below the wings. The landing gear is designed built to withstand the severe loads arising from landing in particular, and is built to an appropriately high level of strength and robustness for this purpose. In contrast, the nose gear does not have to withstand any stresses on landing. It is merely requires to support the weight of the nose of the aircraft. The nose gear may also be used for steering the aircraft under its own power at low speeds. However this does not apply much stress to the nose gear. An aircraft's nose gear is thus designed and built to withstand only the limited forces involved in pushing and towing the aircraft. They are thus relatively easily damaged, or “deemed to be damaged” when an aircraft's nose gear receives an overload which does not cause any. actual damage to the nose gear but which for safety reasons necessitates the repair and/or replacement of the nose gear according to the aircraft manufacturer's manual.

A second problem is that when the nose gear is pulled at an angle other than along a straight line projected along the longitudinal axis of the plane, the force which can be applied to the nose gear without damaging the nose gear, decreases. That is because an aircraft's nose gear is not designed to take loading at an angle. The problem is exacerbated since the changes in the momentum of the plane due to acceleration and deceleration, pass through the nose gear and some journeys involve a large number of stops and starts all of which puts stress on the nose gear. Thus, existing tugs require and carry sophisticated measuring devices to measure the forces on the nose gear and ensure that they do not exceed a level beyond which the nose gear is damaged or is deemed to have been damaged.

The inability of the nose gear to take loading at an angle, restricts the turning circle of current aircraft tugs.

It is an object of the present invention to provide improvements to airport tugs which address and alleviate some or all of the problems associated with existing airport tugs.

### SUMMARY OF THE INVENTION

In a first aspect of the present invention, there is provided a tractor for towing an aircraft including a nose wheel clamping means for lifting and simultaneously clamping a nose wheel of an aircraft, the nose wheel clamping means comprising a first lever, means for raising the first lever, an arm fixed to one and of the first lever, a second lever of approximately the same length as the arm mounted on a pivot defined on the one end of the first lever, approximately where the arm and the first lever meet, a first shoe disposed on a free end of the arm distal from the pivot, a second shoe located at the end of the second lever distal from the pivot, the arrangement being such that in use the wheel is engaged between the two shoes and when the first lever is raised, the clamping force applied to the wheel is proportional to the mass of the aircraft.

In this way the clamping force applied to the wheel is proportional to the weight of the aircraft and the nose wheel sees no more force than it would see when resting on the ground supporting the weight of the nose of the aircraft.

It is preferred that the tug is articulated comprising a front section including engine means for driving the tug and a rear section joined to the front section by an articulated joint, the rear section defining the nose wheel clamping means.

The articulation of the airport tug, means that when the tug turns to turn the plane at an angle, the angle of the forces acting on the nose wheel is reduced as the tug can articulate itself to accommodate the turn.

In a particularly preferred embodiment, the rear section defines a generally U-shaped or forked outer/base frame and an inner frame which is mounted on the outer frame and is movable relative thereto. The nose wheel clamp means is attached to the inner frame which is connected to the outer frame by means of one of more hydraulic cylinders which are operable to raise the inner frame (and hence the nose wheel/gear) relative to the outer frame.

It is preferred that the nose wheel clamp means for receiving the nose wheel of the aircraft are located generally in line with the wheels of the rear portion of the tug. Typically, the rear portion of the tug will include two pairs of coaxial wheels located at either side of the generally U-shaped outer/base frame of the rear section of the tug.

A preferred feature of the invention, is the provision of relief valves associated with the hydraulic cylinders disposed between the outer and inner frames of the rear section. The valves are set to relieve if the force transmitted through the hydraulic cylinder increases beyond a predetermined limit which is set below the threshold beyond which the nose gear is deemed to be damaged.

This feature of the invention provides relief if the forces applied to the nose wheel increase towards a pre-set threshold and thus cushion the effect of severe acceleration, deceleration and turning on the nose wheel, smoothing the forces applied to the nose wheel and reducing the likelihood of the nose wheel receiving forces of a level such that the nose wheel would be deemed damaged, In a way, this is similar to the provision of a sheer pin in a conventional tow bar.

A yet further preferred feature of the present invention, provides a shoe for a tyre characterized in that the shoe extends around greater than one third of the circumference of the tyre.

A stop means may be provided to prevent pivoting of the shoe away from the tyre.

Thus a restraint is provided to prevent pitching up of the nose wheel. In prior art “towbarless” tractors this is achieved by use of a separate lever, which has to be lowered after clamping has taken place.

### BRIEF DESCRIPTION OF THE DRAWINGS

Specific embodiments of the invention will now be described by way of example only and with reference to the accompanying drawings in which:

FIG. 1 is a schematic plan view of a first embodiment of an aircraft tug embodying the present invention;

FIG. 2 is a schematic plan view of the aircraft tug of FIG. 1 illustrating the turning circle of the tug in comparison with an existing unarticulated tug of similar size;

FIGS. 2a and 2b schematically illustrate and compare forces on the nose gear of an aircraft when turning;

FIG. 3 is a plan view of a rear section of the tug of FIG. 1 showing the rear section in more detail;

FIG. 4 is a schematic side view of the rear section of the tug;

FIG. 5 illustrates relative movement between an inner and an outer frame of the rear section of the tug;

FIG. 6 is a side view of the nose gear clamping means for engaging and retaining the nose gear of the aircraft;

FIG. 7 is a schematic view illustrating the principals of operation of the clamping means of FIG. 6;

FIG. 8 is a schematic drawing of a variation on a shoe arrangement for the clamping means;

FIG. 9 is a perspective view of the underside of the rear section of the first embodiment including the enlarged shoes of FIG. 8;

FIG. 10 is a schematic plan view of a second embodiment of an aircraft tug;

FIG. 11 is an isometric view of a pivoting wheel clamp of the embodiment of FIG. 10; and

FIG. 12 schematically illustrates a mechanical lock for the arm of the wheel clamp of FIG. 11.

### DETAILED DESCRIPTION OF PREFERRED EMBODIMENTS

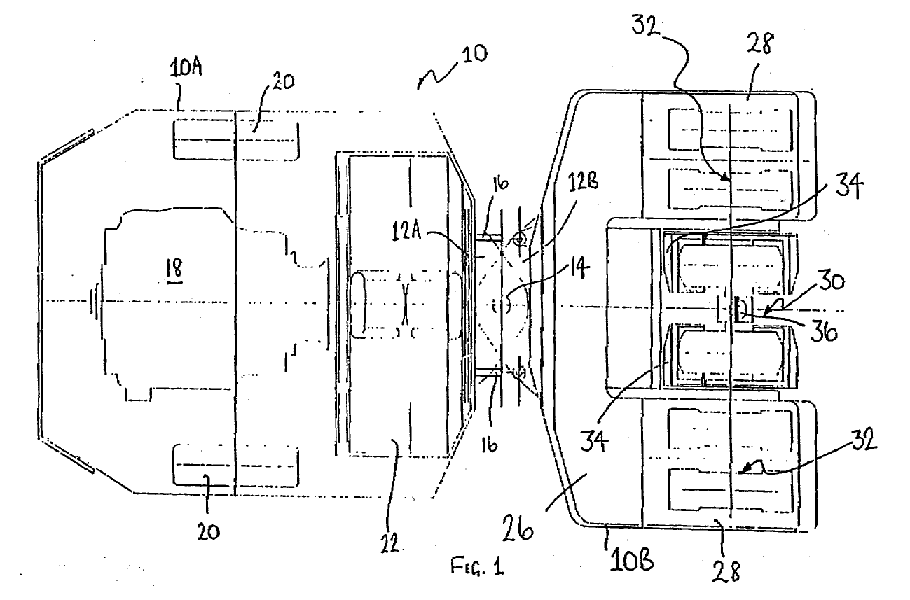

Referring to the drawings, FIG. 1 shows a plan view of an aircraft tractor in the form of an aircraft tug. The tug comprises a front section 10A and a rear section 10B linked by an articulated joint 12 comprising plates 12A, 12B extending from the front and rear sections respectively each of which defines an aperture 14 through which a pivot pin or the like extends to link the two sections. A pair of hydraulic cylinders 16 extend between the front and rear sections and may be used to stear the tug.

The front part of the tug includes an engine 18 which drives a pair of driving wheels 20. The front section also includes a control cab 22.

The rear section 10B of the tug is generally U-shaped having a transverse section 26, two arms 28 extending away from the transverse section at right angles thereto and a gap 30 defined between the arms. The rear section is supported by two pairs of wheels 32 disposed either side of the gap. A clamping means 34 for receiving and clamping the nose gear 36 of an aircraft and retaining the same in line with the rear wheels 32 of the tug is defined in the gap. The clamping means 34 is described in more detail below.

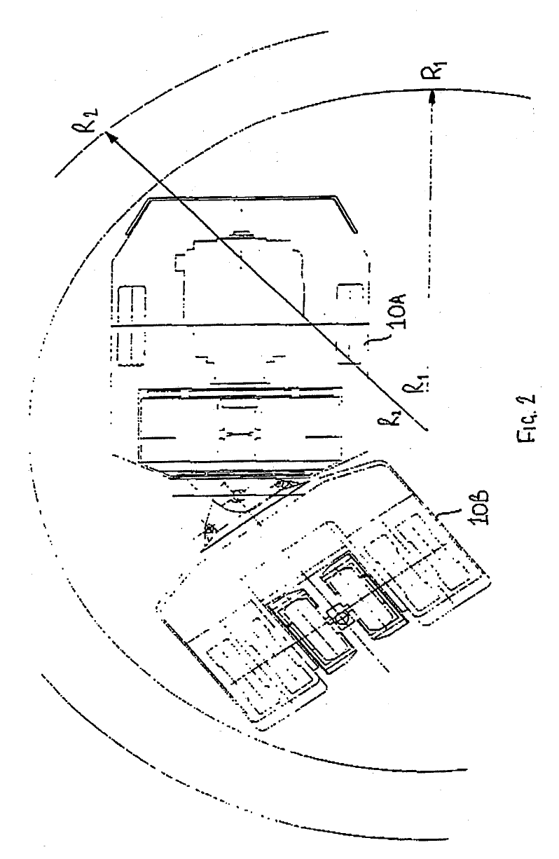

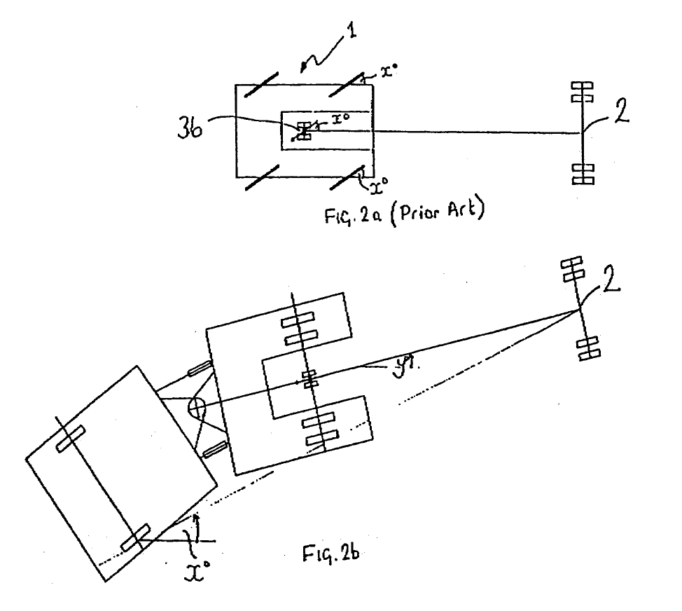

FIG. 2 illustrates a first feature of the present invention in that the articulated tug of the present invention has a smaller turning circle R₁ which is approximately 6 metres compared with an equivalent existing model unarticulated tug whose turning circle would be around 7½ metres. However, whilst this feature is advantageous, the principal advantage of the articulation is not the reduced turning circle of the tug itself, but the reduction in the angle at which the nose wheel 36 of the jumbo jet is pulled when the plane is turned which is illustrated in more detail in comparative drawings 2a and 2b.

As can he seen from FIG. 2a, when an existing model “towbarless” tug 1 turns about an angle “x” to turn the plane about its main gear 2, the forces F transmitted to the nose gear act on the nose gear 36 at the same angle x. As discussed in the introduction, an aircraft's nose gear is not designed to take loading at an angle. The forces which are permitted to be applied to the nose wheel decrease as the angle x increases from 0. When x reaches a certain limit value, no forces may be applied. This limits the permissible turning circle and acceleration/deceleration forces which may be applied to the wheel and hence, limits the speed and maneuverability of the tug when towing an aircraft.

Referring to FIG. 2b, it can be seen that as the front section turns to bring the aircraft to turn at the same angle x as with the prior art tug, because of the articulation of the tug 10 embodying the present invention, the nose wheel turns by a lesser angle y and the forces acting on the nose gear are thus much reduced.

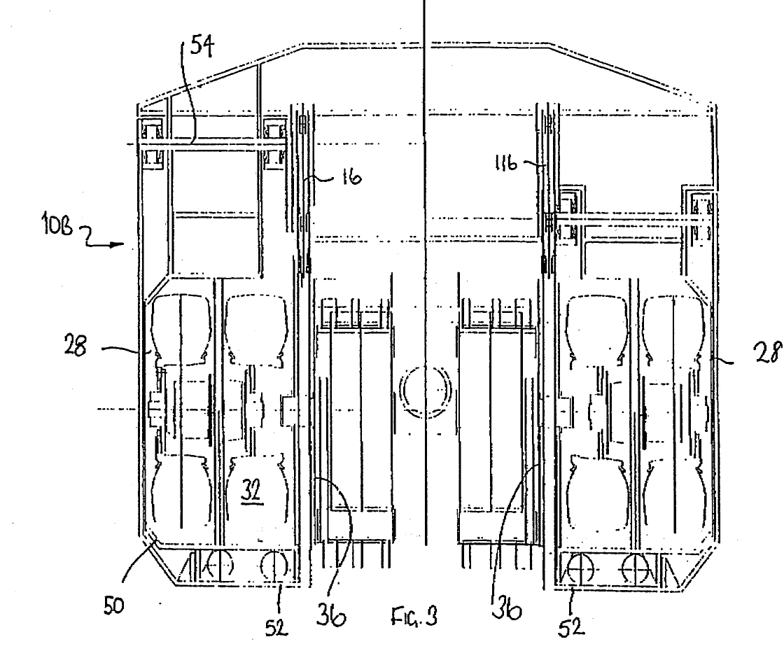

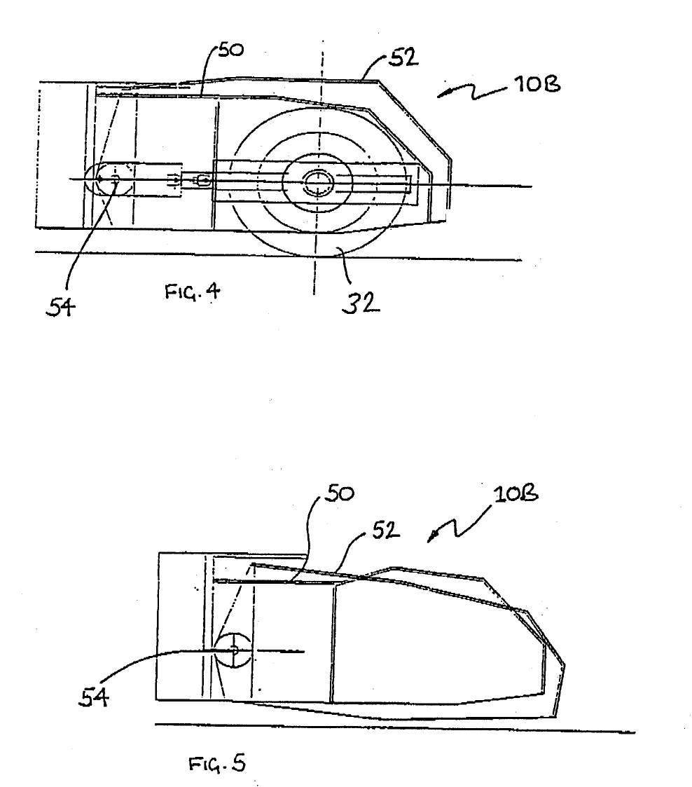

FIGS. 3 to 5, illustrate the features of the rear section 10B of the frame in more detail. The rear section comprises an outer or base frame 50 which is generally U-shaped as discussed above and includes an inner frame 52 which is mounted on the outer frame 50. The clamping means 36 is fixed to the inner frame. The inner frame 52 is mounted to the outer/base frame 50 on a horizontally oriented pivot 54 which extends parallel to the axis of the support wheels. Raising and lowering the inner frame 52 relative to the outer frame 50 when an aircraft's nose gear 36 is clamped relative to the inner frame by the clamp means 34, raises and lowers that nose wheel about the pivot 54 and thus raises and lowers the pivot relative to ground. FIG. 5 illustrates the inner frame 52 in a lowered position. FIG. 4 illustrates the inner frame 52 in a relatively raised position. The inner frame 52 is moved relative to the outer/base frame 50 by means of two pairs of hydraulic cylinders 54 mounted in the free ends of the arms 28 of the U mounted in a generally vertical orientation between the inner frame and the under side of the top of the outer frame 32.

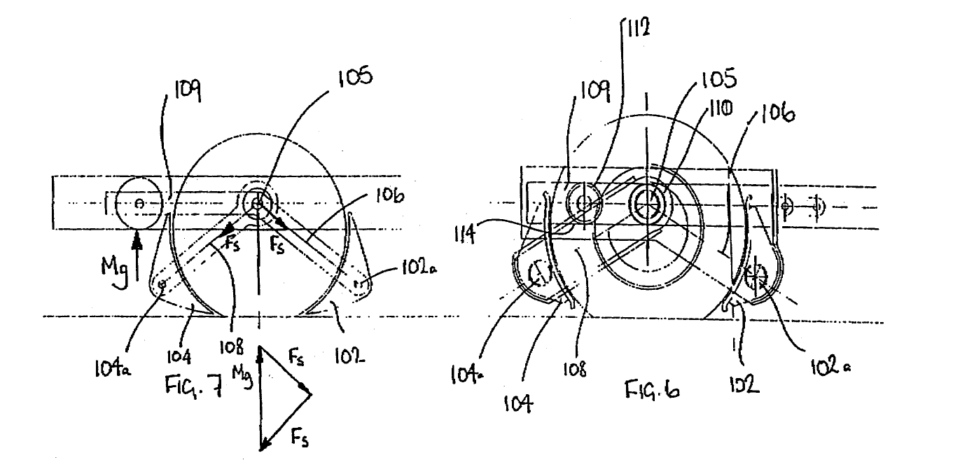

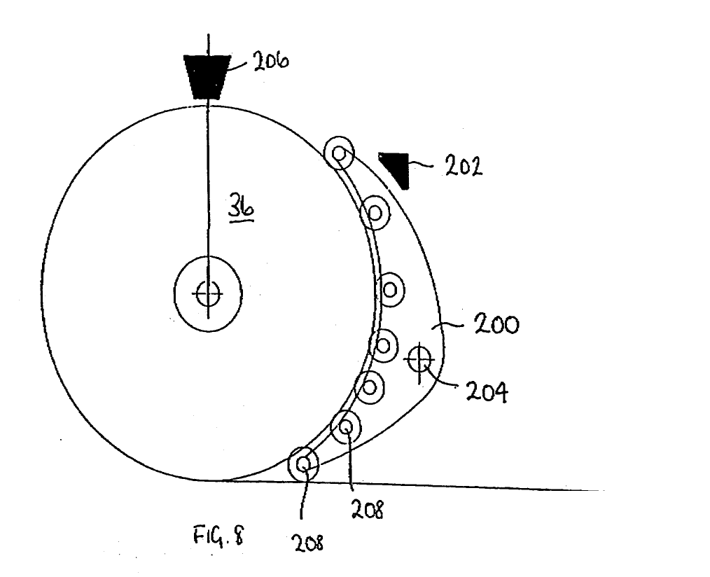

FIGS. 6 and 7 illustrate the clamping and raising mechanism for the nose gear of the aircraft.

The clamping means includes two opposed shoes 102 and 104. They are both mounted to a pivot 105 via an arm 106 and a lever 108 respectively. Each shoe 102, 104 is rotatable mounted about a respective pivot axis 102a, 104a, on the free end of its respective arm/lever. The lever is free to rotate about the pivot 105. The arm 106 extends beyond the pivot to define a second lever 109 which is mounted on rollers 110, 112 and which runs along a channel 114. FIG. 7a is a schematic drawing of the arrangement. Arm 106 is always in the same fixed orientation relative to the fixed lever 109.

When the wheel is lifted the weight Mg of the nose portion of the aircraft which was supported by the nose gear of the aircraft is supported by the toggle clamping means. The weight Mg is resolved into two opposite force vectors Fs. Fs is always proportional to and less than Mg. The forces Fs ideally act close to but below the pivots 102a, 104a of the respective shoes so that a small couple is applied to the shoes which biases the shoes to pivot slightly and thus clamp the upper part of the wheel.

The above-described clamping arrangement allows the nose gear to be simultaneously lifted and toggle clamped, with the clamping force proportional to but never more than the weight of the nose of the aircraft, i.e., the contact force of the nose of the aircraft on the ground—which is the weight that the nose gear is designed to take. This makes the toggle clamping arrangement inherently safe.

The lever 109 is moved along the channel 114 by means of a hydraulic cylinder 116. There are two channels and two cylinders, one disposed on either side of the gap 30.

FIG. 8 illustrates a variant of the invention in which each shoe 200 (only one is illustrated) extends around at least one third and up to almost around half of the circumference of the tyre of the nose gear. A locking bar 202 retains the shoe in place, preventing it pivoting away from the tyre about pivot 204. The locking bar may be hydraulically operated by a solenoid. A restraint 206 prevents the nose wheel 36 from pitching upwards.

A series of small wheels 208 may optionally be provided on the inner face of the shoes to allow the wheels of the nose gear to rotate when the nose gear is secured within the clamping means.

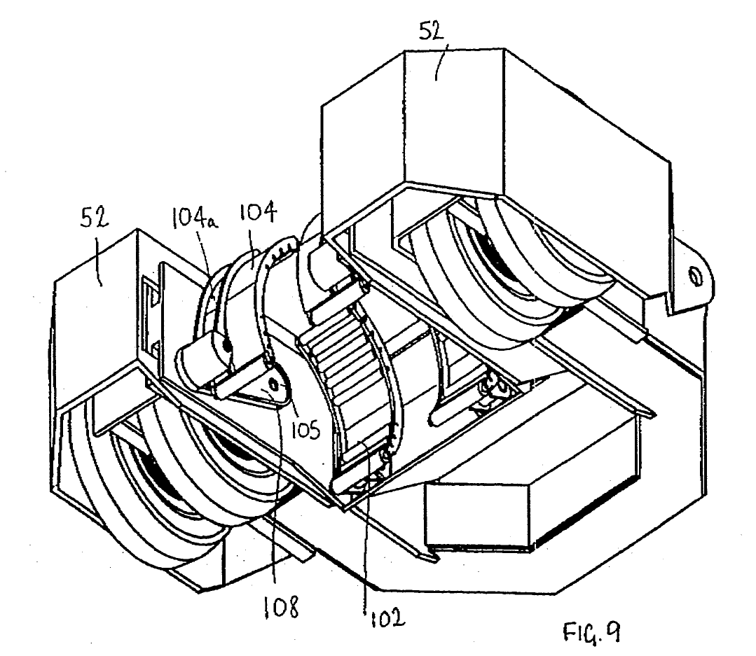

FIG. 9 illustrates the rear section of the tug incorporating larger shoes similar to those shown in FIG. 8.

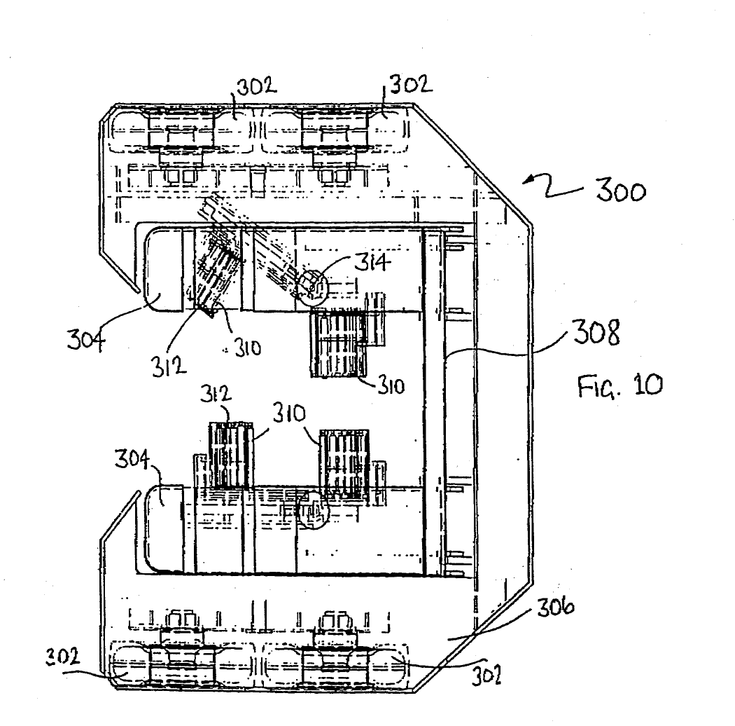

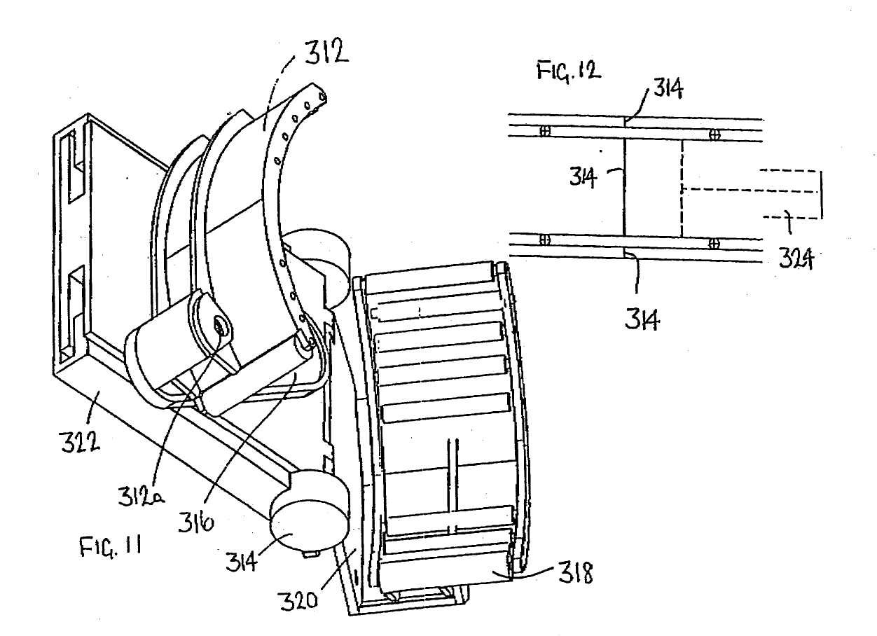

There is however a problem which arises when large shoes are used to clamp the nose wheel of an aircraft. The shoe must be moved out of the way in order for the aircraft's nose gear to enter the gap in the rear section for clamping. In the embodiment shown in FIGS. 1 to 9 the rearmost shoes 104 are rotated upwards and towards the transverse section on the arm about axis 105. The nose gear is then positioned in the gap 30 by moving the tractor/rear section, and the shoes are flipped back for engagement with the nose gear. The problem with this approach is that the shoe 104 tends to block the view of the operator in the control cab 22 which makes reversing the tug to correctly engage with the nose gear quite difficult. One option for solving this problem is to have a second person guide the driver. However this is inefficient in terms of manpower. Thus FIGS. 10 and 11 illustrate a second embodiment or variant of the present invention which addresses this problem.

FIG. 10 illustrates the rear section 300 of the second embodiment. The front section may be identical to that of the first embodiment. In this second embodiment the wheels 302 of the rear section are in-line rather than co-axial. The inner frame is replaced by two arms 304 which are mounted to a U-shaped outer frame 306 about a pivot axis 308. The arms may in theory be moved independently although in practice they are likely to be moved in synchronization. Nose wheel clamping means 310 are fixed to the inner side of each of the arms and provide the same toggle clamping mechanism to the first embodiment as the arms are lifted about the pivot which mechanism directs the forces exerted by the clamping mechanism on the nose gear.

As can be seen from FIG. 10 the in-line wheel arrangement allows for the provision of spaces between the nose clamping means 310 and the wheel themselves 302. Thus as illustrated in the Figure the rearmost shoes 312 can be pivoted sideways about a vertical axis 314 for insertion of a aircraft's nose gear into the clamping means, as with the first embodiment one shoe 312 is mounted on a moving arm 316 (equivalent to lever 108) about a pivot axis 312a. The other shoe 318 is pivoted to one end of an arm (equivalent to arm 106) which is fixed relative to lever/carriage 320 (equivalent to lever 109). The lever/carriage 320 slides along channel 322 on rollers, not shown.

In the case of the second embodiment the lever/carriage 320 defines a vertical hinge 314. For safety reasons it is preferred that the hinge is locked when the clamping means are in operation and consequently a hydraulic cylinder or the like are used to displace the carriage 320 relative to the channel 322 as is illustrated schematically in FIG. 12, for the hinge to be able to swing outwardly about axis 314, the hinge lines 314 of the carriage and channel must coincide. If the carriage is displaced relative to the channel by for example a hydraulic cylinder 324, which might also function as a relief or overload prevention device as described earlier in connection with the first embodiment, the hinge axis 314 moves and a mechanical lock is provided which prevents the hinge from operating.

In this embodiment the swinging of the rearmost shoes to one side obviates the problems of operator visibility of the first embodiment.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A tractor for towing an aircraft including a nose wheel clamping means for lifting and simultaneously clamping a nose wheel of an aircraft, the nose wheel clamping means comprising a first lever, means for raising the first lever, an arm fixed to one end of the first lever, a second lever of approximately the same length as the arm mounted on a pivot defined on the one end of the first lever, approximately where the arm and the first lever meet, a first shoe disposed on a free end of the arm distal from the pivot, a second shoe located at the end of the second lever distal from the pivot, the arrangement being such that in use the wheel is engaged between the two shoes and when the first lever is raised, the clamping force applied to the wheel is proportional to the mass of the aircraft.

2. A tractor for towing an aircraft as claimed in claim 1 wherein the tractor includes a front section including engine means for driving the tractor and a rear section pivoted to the front section said means for lifting and simultaneously toggle clamping a nose wheel of an aircraft being defined on the rear section.

3. A tractor as claimed in claim 2 wherein the rear section comprises an outer frame and an inner frame which is mounted on the outer frame and is movable relative thereto and including means for raising the inner frame relative to the outer frame wherein the nose wheel clamp means is attached to the inner frame.

4. A tractor as claimed in claim 3 wherein the means for raising the inner frame relative to the outer frame includes one or more hydraulic cylinders.

5. A tractor as claimed in claim 4 wherein the inner and outer frames are forked.

6. A tractor as claimed in claim 4 wherein relief valves associated with the hydraulic cylinders are disposed between the outer and inner frames of the rear section, the valves being arranged to relieve if the force transmitted through the hydraulic cylinder increases beyond a predetermined limit.

7. A tractor as claimed in claim 1 wherein the nose wheel clamping means include at least one shoe mounted on an arm which is pivoted to a carriage which carriage defines a substantially vertical hinge to allow the carriage to be pivoted about a vertical axis to swing the shoe to one side.

8. A tractor for towing an aircraft as claimed in claim 1 characterized in that the shoe extends around greater than one third of the circumference of the nose wheel tyre or tyres of the aircraft, in use.

9. A tractor as claimed in claim 8 further including a stop means for preventing pivoting of the shoe away from the tyre.

10. A tractor for towing an aircraft, the tractor defining a front section including an engine means for driving the tractor and a rear section pivoted to the front section, said rear section defining a nose wheel clamping means for lifting and simultaneously clamping a nose wheel of an aircraft, the nose wheel clamping means comprising a first lever, means for raising the first lever, an arm fixed to one end of the first lever, a second lever of approximately the same length as the arm mounted on a pivot defined on the one end of the first lever, approximately where the arm and the first lever meet, a first shoe disposed on a free end of the arm distal from the pivot, a second shoe located at the end of the second lever distal from the pivot, the arrangement being such that in use the wheel is engaged between the two shoes and when the first lever is raised, the clamping force applied to the wheel is proportional to the mass of the aircraft.

11. A tractor as claimed in claim 10 wherein the rear section comprises an outer frame and an inner frame which is mounted on the outer frame and is movable relative thereto and including means for raising the inner frame relative to the outer frame wherein the nose wheel clamp means is attached to the inner frame.

12. A tractor as claimed in claim 11 wherein the means for raising the inner frame relative to the outer frame includes one or more hydraulic cylinders.

13. A tractor as claimed in claim 11 wherein the inner and outer frames are forked.

14. A tractor as claimed in claim 13 wherein relief valves associated with the hydraulic cylinders are disposed between the outer and inner frames of the rear section, the valves being arranged to relieve if the force transmitted through the hydraulic cylinder increases beyond a predetermined limit.

15. A tractor as claimed in claim 14 wherein the nose wheel clamping means includes at least one shoe mounted on an arm which is pivoted to a carriage which carriage defines a substantially vertical hinge to allow the carriage to be pivoted about a vertical axis to swing the shoe to one side.

16. A tractor for towing an aircraft as claimed in claim 15 characterized in that the shoe extends around greater than one third of the circumference of the nose wheel tyre or tyres of the aircraft, in use.

17. A tractor as claimed in claim 16 further including a stop means for preventing pivoting of the shoe away from the tyre.
